(19) United States
(12) Patent Application Publication
(10) Pub. No.: US 2007/0076657 A1
(43) Pub. Date: Apr. 5, 2007

(54) METHOD FOR CHANNEL AGILITY IN WIRELESS ACCESS POINTS

(75) Inventors: Ryan Winfield Woodings, Boise, ID (US); Manoj Pandey, Boise, ID (US)

Correspondence Address: MARGER JOHNSON & MCCOLLOM, P.C., 210 SW MORRISON STREET, SUITE 400, PORTLAND, OR, 97204, US

(73) Assignee: CYPRESS SEMICONDUCTOR CORPORATION, San Jose, CA (US)

(21) Appl. No.: 11/468,534

(22) Filed: Aug. 30, 2006

Related U.S. Application Data
(60) Provisional application No. 60/713,917, filed on Sep. 1, 2005.

(51) Int. Cl. H04Q 7/00

(52) U.S. Cl. 370/329; 455/67.13; 455/509

(57) ABSTRACT

A system and method comprising automatically detecting signal activity associated with a frequency band having a plurality of channels for wireless communication, automatically identifying at least one channel having a low level of signal activity relative to one or more other channels associated with the frequency band, and selecting at least one of the identified channels for communicating over the frequency band.

### REFERENCE TO RELATED APPLICATIONS

This application claims priority from U.S. Provisional Application No. 60/713,917, filed Sep. 1, 2005, which is incorporated herein by reference.

### FIELD OF THE INVENTION

This invention relates generally to wireless communication, and more specifically to channel agility in wireless access points.

### BACKGROUND OF THE INVENTION

Wireless networks, such as Wireless Fidelity (Wi-Fi) or IEEE 802.11 standard networks, couple to access points that wirelessly communicate with devices, such as personal computers. These access points may communicate over a 2.4 ISM GHz band in one of a plurality of channels. For instance, 802.11 networks typically include 11 to 14 overlapping channels that are approximately 22 MHz wide and have center frequencies staggered 5 MHz apart.

Conventional access points have a web-based interface that allows users to manually configure the access points, such as by selecting a channel for communications over the wireless network, or by setting passwords and access parameters. Since there is no way of identifying the best channel for communication without specialized equipment and training, many users arbitrarily select a channel or use a default channel preset in the access point.

There are many devices that may interfere with wireless communications by an access point. For example, 802.11 channels may receive interference from microwave ovens, cordless telephones, Blue Tooth enabled devices, and/or other devices operating in the unlicensed 2.4 GHz ISM band. Since most users are unaware when wireless interference occurs, they often assume that the access point is malfunctioning and thus have a negative overall customer experience.

Conversely, when users realize that channel interference is degrading their wireless communications, conventional access points require them to re-access the web-based interface and manually select another channel. This manual channel selection, however, is generally an unwelcome complication, which often times must be repeated since these access points provide no help to the user in determining whether the newly selected channel will improve their wireless communication.

### DESCRIPTION OF THE DRAWINGS

The invention may be best understood by reading the disclosure with reference to the drawings.

FIG. 1 illustrates, in block form, a wireless communication system useful with embodiments of the present invention.

FIG. 2 shows a flowchart illustrating example operations of an access point shown in FIG. 1.

FIG. 3 shows another flowchart illustrating example operations of the access point shown in FIG. 1.

FIGS. 4A and 4B show a graphical illustration of example operations of the access point shown in FIG. 1.

FIG. 5 illustrates, in block form, another wireless communication system useful with embodiments of the present invention.

### DETAILED DESCRIPTION

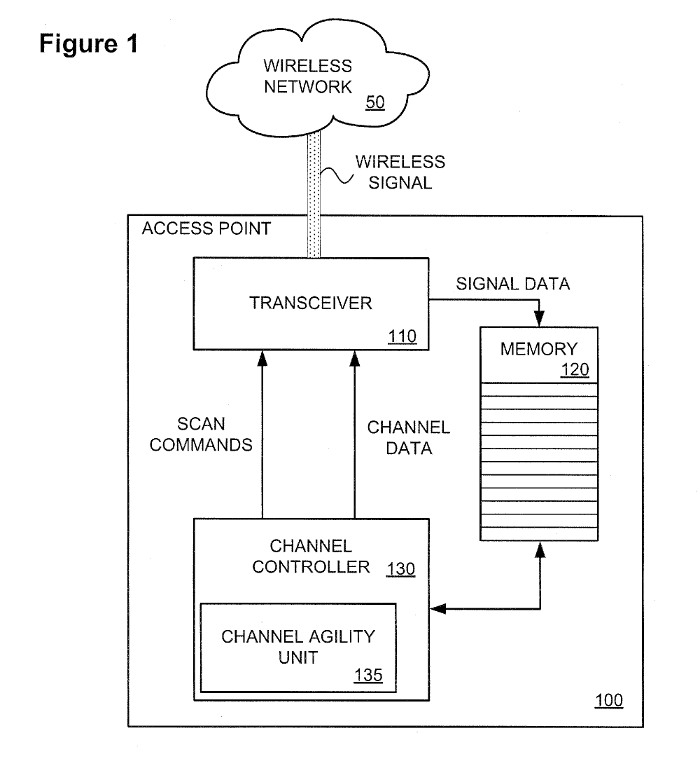

FIG. 1 illustrates, in block form, a wireless communication system useful with embodiments of the present invention. Referring to FIG. 1, the wireless communication system includes an access point 100 configured to communicate over a wireless network 50. The wireless network 50 may be a Wireless Fidelity (Wi-Fi), an IEEE 802.11 standard network, or any other network allowing communications over a wireless frequency band, such as the 2.4 ISM GHz frequency band.

The wireless network 50 includes a plurality of channels for the access point 100 to communicate. For example, an 802.11 wireless network 50 may include 11 to 14 overlapping channels that are approximately 22 MHz wide and have center frequencies staggered 5 MHz apart. The access point 100 may transmit and receive wireless signals through one or more of the channels of the wireless network 50.

The access point 100 includes a transceiver 110 to communicate over the wireless network 50. In some embodiments, the transceiver 110 may detect signal activity, such as noise and/or signals originating from other devices, present on one or more channels of the wireless network 50. For instance, the transceiver 110 may receive wireless signals associated with one or more frequencies of the wireless network 50 and store signal data associated with the wireless signals to a memory 120. The transceiver 110 may continuously, periodically, and/or intermittently scan frequencies associated with the wireless network 50 to detect this signal activity. In some embodiments, the access point 100 may separately include a receiver (not shown) for receiving signals from the wireless network 50 and/or a transmitter (not shown) for transmitting signals over the wireless network 50.

The access point 100 includes a channel controller 130 to control which channel of the wireless network 50 the access point 100 uses to communicate. For instance, the channel controller 130 may provide channel data to the transceiver 110 that indicates which channel the access point 100 is to use to communicate over the wireless network 50. In some embodiments, the channel controller 130 may store the channel data to the memory 120, where the transceiver 110 may access the stored channel data to identify the channel used to communicate over the wireless network 50.

The channel controller 130 includes a channel agility unit 135 to determine which channel the access point 100 uses to communicate over the wireless network 50. The channel agility unit 135 may determine the channel to be used by the access point 100 responsive to signal activity, such as noise and/or signals originating from other devices, present in the wireless network 50. Since the presence of signal activity in the wireless network 50 may increase the potential for interference with communications by the access point 100, the channel agility unit 135 may identify one or more channels having a lower level of signal activity than at least one of the other channels, In some embodiments, the channel agility unit 135 may select the quietest channel or the channel with the least amount of signal activity.

The channel agility unit 135 may issue a request for the transceiver 110 to initiate detection of signal activity associated with the wireless network 50. For instance, the channel agility unit 135 may provide scan commands to the transceiver 110 to initiate a signal activity scan of the wireless network 50 and/or to identify one or more frequencies or a range of frequencies to be scanned by the transceiver 110. The channel agility unit 135 may identify the signal activity associated with the wireless network 50 by accessing the signal data in the memory 120, or in some embodiments, by directly receiving the signal data from the transceiver 110. Embodiments of the channel controller 130 and the channel agility unit 135 will be described below in greater detail.

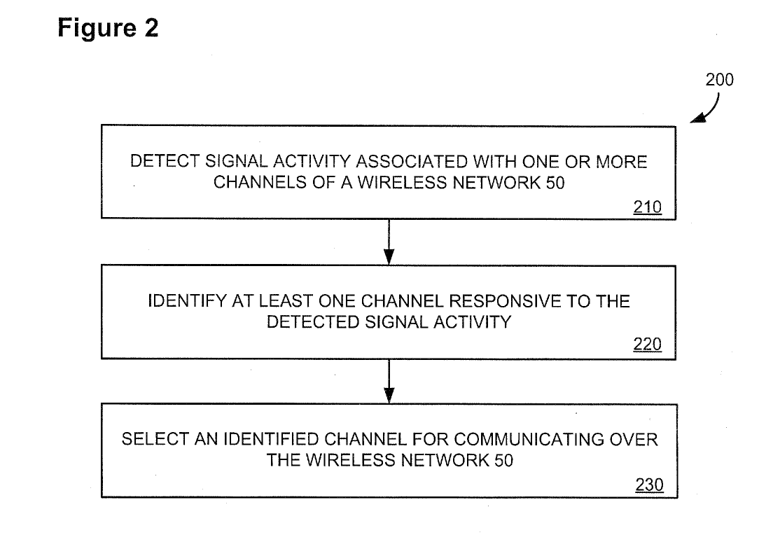

FIG. 2 shows a flowchart 200 illustrating example operations of the access point 100 shown in FIG. 1. Referring to FIG. 2, in a block 210, the access point 100 detects signal activity associated with one or more channels of the wireless network 50. In some embodiments, the access point 100 may sequentially scan frequencies of the wireless network 50 to detect the signal activity. For instance, the transceiver 110 may scan a first frequency range of the wireless network 50 for signal activity, e.g., a 1 MHz section of the frequency band, and then proceed to another frequency range of the wireless network 50. The access point 100 may perform these scans continuously, periodically, intermittently, and/or responsive to one or more scan commands from the channel controller 130.

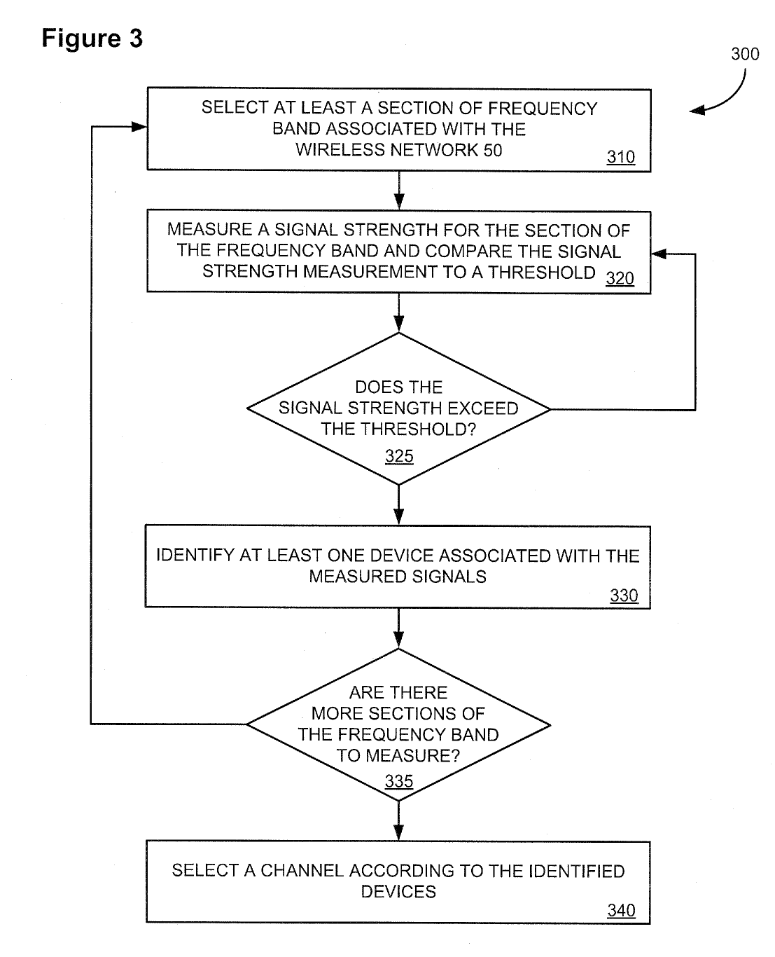

As will be discussed below in greater detail in FIG. 3, the access point 100 may also scan the wireless network 50 to determine the type of device emitting or transmitting signals that occupy one or more channels the wireless network 50. For instance, the transceiver 110 may repeatedly scan the same frequency range of the wireless network 50 to determine the duration of the signal activity present in that frequency range, and the channel agility unit 135 may then determine the type of device transmitting the signal responsive to the duration of signal activity.

In block 220, the access point 100 identifies at least one channel for wireless communications responsive to the detected signal activity. The identified channel may have a low level of signal activity relative to one or more other channels associated with the wireless network 50, thus reducing the probability that the access point 100 experiences interference when communicating over the wireless network 50.

In some embodiments, the channel agility unit 135 may identify the channel responsive to signal data generated during at least one scan by the transceiver 110. The channel agility unit 135 may correlate the signal data to one or more of the channels and identify at least one of the channels responsive to the correlated signal data. For instance, the channel agility unit 135 may average the signal data associated with each channel and then determine a channel with low signal activity responsive to the average signal data associated with the channel. In some embodiments, the channel agility unit 135 may rank the channels according to their average signal activity and optionally store the ranking to the memory 120.

In block 230, the access point 100 selects an identified channel to communicate over the wireless network 50. In some embodiments, the channel agility unit 135 may select the identified channel by providing channel data to the transceiver 110 or by storing the channel data to memory 120.

This selection may occur during initial configuration of the access point 100, when communications over the wireless network 50 undergo channel interference, or when channel currently used by the access point 100 has higher level of detected signal activity than another channel associated with the wireless network 550. In some embodiments, the access point 100 may provide the identified channel(s) to a user for a manual selection of a channel for communication over the wireless network 50.

FIG. 3 shows another flowchart 300 illustrating example operations of the access point shown in FIG. 1. Referring to FIG. 3, in a block 310, the access point 100 selects at least a section of frequency band associated with the wireless network 50. The section of the frequency band may be a discreet frequency range, such as a 1 MHz increment of the frequency band, or a channel. In some embodiments, the channel agility unit 135 selects the section of the frequency band and provides scan commands to the transceiver 110 identifying the selected section of the frequency band.

In a block 320, the access point 100 measures signal strength corresponding to the section of the frequency band and compares the signal strength measurement to a threshold. The threshold may be preset in the access point 100 or, in some embodiments, the access point 100 may determine the threshold.

In a decision block 325, the access point 100 determines whether the signal strength exceeds the threshold. When the signal strength measurement exceeds the threshold, execution returns to block 320 where the access point 100 re-measures the signal strength for the section of the frequency band and compares the new measurement to the threshold. This loop between blocks 325 and 330 may continue until a new signal strength measurement falls below the threshold, or a preset period of time elapses.

When the signal strength measurement does not exceed the threshold, execution proceeds to block 330, where the access point 100 identifies the measured signals as associated with at least one device. The access point 100 may identify the device(s) associated with the measured signals according to an inter-packet gap. The inter-packet gap may determined according to the time period between point when the access point 100 measures a signal strength that exceeds the threshold and a signal strength for the same section of the frequency band that falls below the threshold.

The inter-packet gap may be the duration of the signal occupying the section of the frequency band. For instance, signals with a 10-40 millisecond duration may correspond another 802.11 access point, while signals 0.5-2 milliseconds in duration are typically Bluetooth signals. In some instances, the duration of the signal may remain continuous indicating that the device may be a cordless phone or a microwave. In some embodiments, the access point 100 may store the identification of a device operating in the section of the frequency band to the memory 120 for subsequent use by the access point 100 in channel selection.

In some embodiments, the access point 100 may identify the device(s) associated with the measured signals according to the shape of the signal. The access point 100 may determine the shape of signals by continually sweeping and measuring the frequency band, e.g., in 1 MHz frequency ranges. For instance, 802.11 signals typically have a bell shape that is approximately 22 MHz wide, where cordless phones may have a skinnier bell shape of about 5 MHz wide.

In a decision block 335, the access point 100 determines whether there are more sections of the frequency band to measure. When there are more sections of the frequency band to measure execution returns to block 310 to select another section of the frequency band. Otherwise execution proceeds to block 340, where the access point 340 selects a channel associated with the wireless network 50 responsive to the identified devices. In some embodiments, the channel agility unit 135 may select the channel by providing channel data to the transceiver 110 or by storing the channel data to memory 120.

This selection may occur during initial configuration of the access point 100, when communications over the wireless network 50 undergo channel interference, or when channel currently used by the access point 100 has higher level of detected signal activity than another channel associated with the wireless network 550. In some embodiments, the access point 100 may provide the identified channel(s) to a user for a manual selection of a channel for communication over the wireless network 50.

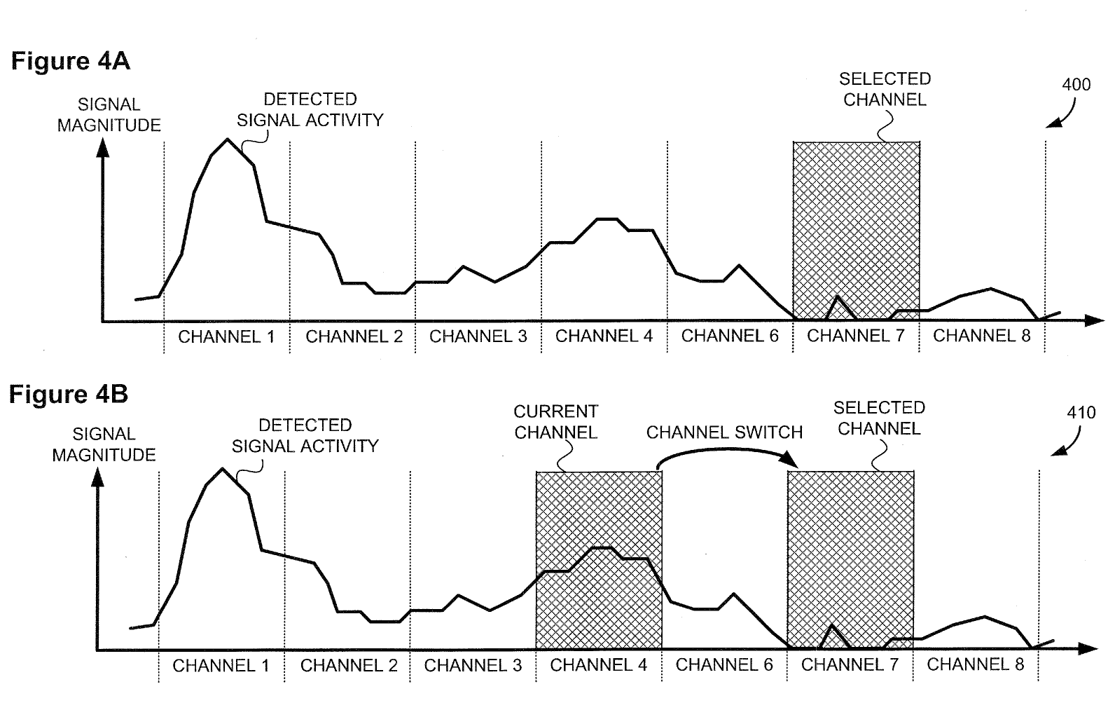

FIGS. 4A and 4B show graphical illustrations 400 and 410 of example operations of the access point 100 shown in FIG. 1. FIG. 4A shows the selection of a channel on the wireless network 50 for communications responsive to detected signal activity, while FIG. 4B shows the switching of channels on the wireless network 50 for communications responsive to detected signal activity.

Referring to FIGS. 4A and 4B, illustrations 400 and 410 show signal activity for multiple channels of wireless network 50, i.e., channel 1-channel 8. In particular embodiments, there may be any number of overlapping or non-overlapping channels associated with the wireless network 50. Although FIGS. 4A and 4B show non-overlapping channels for readability and ease of understanding, in some embodiments the multiple channels may overlap.

Referring to FIG. 4A, the access point 100 may automatically detect signal activity associated with the wireless network 50 and select a channel, e.g., channel 7, for wireless communication. The selected channel may have a lower level of signal activity than other channels associated with the wireless network 50. In some embodiments, the access point 100 may select the quietest channel or the channel with the least amount of signal activity.

Referring to FIG. 4B, the access point 100 is currently using channel 4 for wireless communication. Channel 4, however, has a relatively high level of signal activity compared to other channels in illustration 410. The access point 100 may automatically detect signal activity associated with the wireless network 50, select a channel, e.g., channel 7, for wireless communication, and switch from the current channel, i.e., channel 4, to the selected channel, i.e., channel 7, responsive to the selection. The selected channel, i.e., channel 7, may have a lower level of signal activity than channel 4 and/or one or more other channels associated with the wireless network 50. In some embodiments, the access point 100 may select the quietest channel or the channel with the least amount of signal activity.

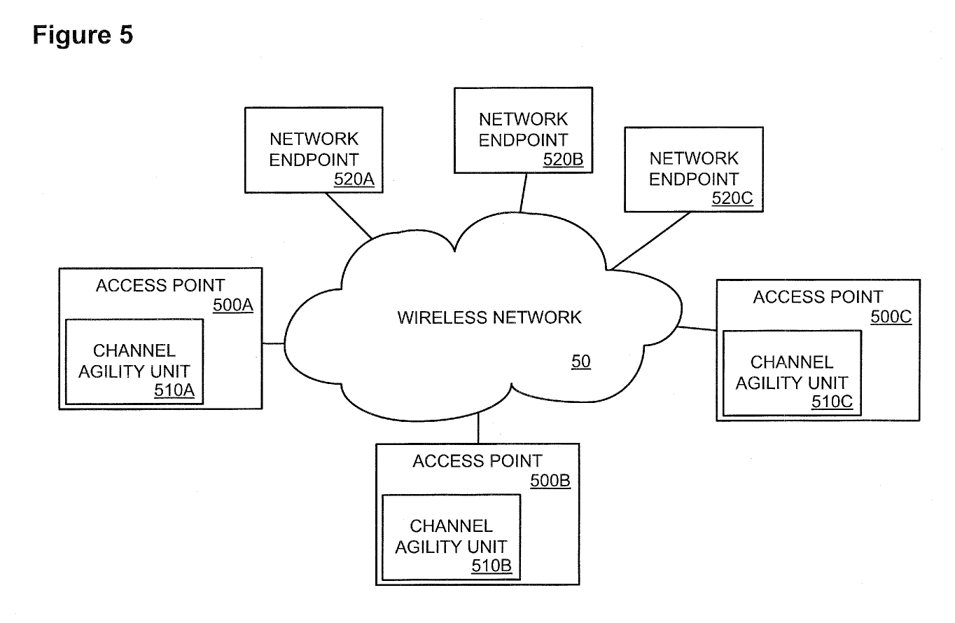

FIG. 5 illustrates, in block form, another wireless communication system useful with embodiments of the present invention. Referring to FIG. 5, the wireless communication system includes multiple access points 500A-500C to communicate with network endpoints 520A-520C over a wireless network 50.

The wireless network 50 may be a Wireless Fidelity (Wi-Fi), an IEEE 802.11 standard network, or any other network allowing communications over a wireless frequency band, such as the 2.4 ISM GHz frequency band. The wireless network 50 includes a plurality of channels for the access points 500A-500C to communicate. For example, an 802.11 wireless network 50 may include 11 to 14 overlapping channels that are approximately 22 MHz wide and have center frequencies staggered 5 MHz apart.

The access points 500A-500C may wirelessly communicate through one or more of the channels of the wireless network 50. When multiple access points 500A-500C decide to communicate via the same channel of the wireless network 50, there is an increased probability that their signals will interfere with each other and thus degrade communications of the access points 500A-500C.

The access points 500A-500C include channel agility units 510A-510C, respectively, to detect signal activity on the wireless network 50 and identify a channel associated with the wireless network 50 to communicate responsive to the detected signal activity. Since the channel agility units 510A-510C may detect the same signal activity conditions associated with the wireless network 50, multiple access points 500A-500C may decide communicate over a common channel.

Since communication by multiple access points 500A-500C over a common channel will increase signal activity for the channel, the access points 500A-500C may subsequently determine switch to another channel of the wireless network 50. Oftentimes the access points 500A-500C will determine to switch to another common channel, where their communications may again interfere with each other. This oscillatory effect of the access points 500A-500C caused by continually switching to the same channel, i.e., the channel with the least signal activity, may continue to degrade the communications.

In some embodiments, the channel agility units 510A-510C. may include oscillatory functionality to help prevent multiple access points 500A-500C from selecting the same channel to communicate over the wireless network 50. For instance, the channel agility units 510A-510C may include a timer that indicates when the corresponding access point 500A-500C may switch to a new channel. The duration associated with the timer may be randomly determined following each selection of a channel. Since each access point 500A-500C may independently set their timer duration and thus switch channels independently, some of the access points 500A-500C may identify channels to switch to after other access points 500A-500C have switched to their new channel. In some embodiments, the multiple access points 500A-500C may communicate with each other, e.g., over the wireless network, to determine which channel each access point 500A-500C will use to communicate with the network endpoints 520A-520C.

One of skill in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A system comprising:
a transceiver to detect signal activity in a wireless network having a plurality of channels; and
a channel controller to identify at least one channel associated with the wireless network having a low level of detected signal activity relative to one or more of the other channels associated with the wireless network, the transceiver to communicate over the wireless network through the identified channel.

2. The system of claim 1
where the channel controller is configured to identify one or more devices operating in the wireless network responsive to the signal activity, and to correlate the signal activity associated with the devices to one or more of the channels; and
where the transceiver is configured to communicate over the wireless network through a channel other than the channels correlated to the devices.

3. The system of claim 2 where the channel controller is configured to determine an inter packet gap associated with the detected signal activity and to identify the devices responsive to the inter packet gap.

4. The system of claim 2 where the channel controller is configured to determine a duration of detected signal activity and to identify the devices responsive to the duration of the signal activity.

5. The system of claim 4
where the transceiver is configured to measure a strength of the signal activity for at least one frequency associated with the wireless network; and
where the channel controller is configured to compare the measured strength of the signal activity to a predetermined threshold value, the transceiver to re-measure the strength of the signal activity when the measured strength of the signal activity exceeds the predetermined threshold value, the channel controller to determine the duration of detected signal activity when the re-measured strength of the signal activity falls below the predetermined threshold value.

6. The system of claim 1 where the channel controller is configured to determine an average level of detected signal activity associated with one or more channels and to select one of the channels according to the average level of detected signal activity.

7. The system of claim 1 including a timer to delay the channel controller in selecting an identified channel for wireless communications, the delay to avoid interference caused by another device switching to the identified channel.

8. The system of claim 1 where the transceiver communicates with an access point associated with the wireless network and the channel controller is configured to select the identified channel responsive to the communication.

9. A method comprising:
detecting signal activity in a frequency band having a plurality of channels for wireless communication;
identifying at least one channel having a low level of detected signal activity relative to one or more other channels associated with the frequency band; and
selecting at least one of the identified channels for communicating over the frequency band.

10. The method of claim 9 includes
determining an inter packet gap associated with the signal activity;
identifying one or more devices operating in the frequency band responsive to the inter packet gap; and
selecting at least one of the identified channels for communicating over the frequency band responsive to the identified devices operating in the frequency band.

11. The method of claim 9 includes
determining a duration of the signal activity associated with one or more channels in the frequency band;
identifying one or more devices operating in the frequency band responsive to the duration of the signal activity; and
selecting at least one of the identified channels for communicating over the frequency band responsive to the identified devices operating in the frequency band.

12. The method of claim 11 includes
measuring a strength of the signal activity associated with one or more frequencies in the frequency band;
comparing the strength of the signal activity to a threshold value;
re-measuring the strength of the signal activity associated with one or more frequencies in the frequency band when the strength of the signal activity is greater than the threshold value; and
computing the duration of the signal activity associated with one or more frequencies in the frequency band when the re-measured strength of the signal activity is less than the threshold value.

13. The method of claim 12 includes
correlating one or more channels to the identified devices operating in the frequency band; and
selecting a channel for communicating over the frequency band other than the correlated channels.

14. The method of claim 9 includes
determining an average level of the signal activity associated with one or more of the channels; and
selecting the channel with the lowest average signal activity to communicate over the frequency band.

15. The method of claim 9 includes
communicating over a first channel associated with the frequency band;
detecting signal activity associated with at least a second channel associated with the frequency band, the second channel having a lower level of signal activity than the first channel; and
switching communications from the first channel to the second channel responsive to the detecting.

16. A method comprising:
detecting signal activity in a wireless network having a plurality of channels for wireless communication;
identifying at least one device occupying one or more channels associated with the wireless network; and
selecting at least one channel for communicating over the wireless network responsive to the identified device operating in the wireless network.

17. The method of claim 16 includes delaying wireless communications over the selected channel to avoid interference caused by a device switching to the second channel.

18. The method of claim 16 includes
determining a duration of the signal activity associated with one or more channels in the frequency band;
identifying one or more devices operating in the frequency band responsive to the duration of the signal activity; and
selecting at least one of the identified channels for communicating over the frequency band responsive to the identified devices operating in the frequency band.

19. The method of claim 18 includes
measuring a strength of the signal activity associated with one or more frequencies in the frequency band;
comparing the strength of the signal activity to a threshold value;
re-measuring the strength of the signal activity associated with one or more frequencies in the frequency band when the strength of the signal activity is greater than the threshold value; and
computing the duration of the signal activity associated with one or more frequencies in the frequency band when the re-measured strength of the signal activity is less than the threshold value.

20. The method of claim 16 includes
determining an average level of the signal activity associated with one or more of the channels; and
selecting the channel with the lowest average signal activity to communicate over the frequency band.
